(19) United States
(12) Patent Application Publication
(10) Pub. No.: US 2015/0322222 A1
(43) Pub. Date: Nov. 12, 2015

(54) ANTISTATIC FILM

(71) Applicant: Innovia Security Pty Ltd, Craigieburn, Victoria (AU)

(72) Inventors: Gary Fairless Power, Craigieburn, Victoria (AU); Michael Bruce Hardwick, Craigieburn, Victoria (AU)

(21) Appl. No.: 14/411,350

(22) PCT Filed: Jun. 14, 2013
(86) PCT No.: PCT/AU2013/000633

§ 371 Date: Dec. 24, 2014

(30) Foreign Application Priority Data
Jun. 28, 2012 (AU) 20122100979

(51) Int. Cl. C08J 7/04

(52) U.S. Cl. CPC C08J 7/042; C08J 2323/12; C08J 2400/12

(57) ABSTRACT

A film having antistatic properties, said film comprising a transparent polymeric substrate, said substrate being partially opacified on at least one surface so as to provide opacified and non-opacified regions and wherein both the opacified and non-opacified regions are coated on at least one surface with an antistatic coating said coating having greater than 70% transmission. In particular for use as a transparent antistatic coating on polymer banknotes including transparent window regions.

### FIELD

The present invention relates to antistatic films and to methods of their preparation. The films may find use in the manufacture of banknotes and the like.

### BACKGROUND

Opacified polymer based films are widely utilised in industry, for example, in the manufacture of banknotes. Polymer derived banknotes often have non-opacified regions in the form of large clear windows or edge to edge windows. These clear windows may contain important security features. During processing of polymer based films these non-opacified areas cause a build up of static electricity, which can lead to problems. In web based sheeting processes jamming can occur. In sheet fed processes and automatic teller machines (ATM), double feeding and jamming can occur. These represent significant problems as the efficiency of the processes may be compromised.

To address this problem, ATM suppliers and banknote printers may use an antistatic bar in their machines, however, this is only a solution for the particular windows currently in use. Antistatic bars on sheeters have been used in the past, but have not been a successful solution when processing films with large windows.

Further, the problem is compounded by the increase in static electricity with decreasing humidity. This can exacerbate processing issues with polymer based banknotes.

While antistatic agents may be utilised directly as part of the opacifying layer, these cannot be used over the windows as they have inadequate transparency and therefore compromise the transparency of the windows.

There is a need to provide improved antistatic coatings that would allow efficient processing of opacified films having clear windows.

### SUMMARY

According to a first aspect there is provided a film having antistatic properties, said film comprising a transparent polymeric substrate, said substrate having a first surface and a second surface, said substrate being partially opacified so as to provide opacified and non-opacified regions, and wherein both the opacified and non-opacified regions are coated on at least one surface with one or more antistatic coatings, said coatings having greater than 70% transmission, preferably greater than 80% transmission, more preferably greater than 90% transmission.

The polymeric substrate may be partially opacified by coating selected regions of one or both surfaces of the substrate with an opacifying coating. One or more opacifying coating layers may be applied. The opacifying coating layers may be applied by printing or by any other means known in the art. The opacifying coating may comprise pigments. Alternatively or additionally, the polymeric substrate may be partially opacified by addition of one or more voiding agents to the substrate. The voiding agent may be added during manufacture of the substrate or it may be added during processing of the substrate. Alternatively, the voiding agent may be added during both manufacturing and processing.

Alternatively or additionally opacification may be achieved by sandwiching the substrate of transparent polymeric material between opacifying layers of paper or other partially or substantially opaque material to which indicia may be subsequently printed or otherwise applied.

Partial opacification of the polymeric substrate results in the generation of one or more windows or one or more half windows in the resulting film. Alternatively, both of one or more windows and one or more half windows may be generated.

In preferred embodiments the opacified and non-opacified regions of the polymeric substrate are coated with an antistatic coating on both surfaces of the substrate.

Preferably the antistatic coating is colourless.

The present inventors have surprisingly found that films based on polymeric substrates which have partially opacified surfaces and transparent windows and/or half windows can be coated with an antistatic coating having a high transparency and show improved antistatic behaviour during processing. As the clear windows and/or half windows often contain security devices, such as holograms or diffractive optical elements (DOEs), then the use of a high transparency antistatic coating minimises interference with the operation of these devices.

It will be appreciated that for films comprising one or more transparent windows preferably the antistatic coating is applied to both surfaces of the substrate. In cases where the film comprises only half windows the antistatic coating may only be applied to the surface of the substrate having a non-opacified region in order to improve antistatic behaviour.

In some embodiments the film may be coated with a protective coating. In some embodiments the protective coating may comprise a transparent varnish. By varnish it is meant a material that results in a durable protective finish. Exemplary transparent varnishes are, but are not limited to, nitrocellulose and cellulose acetyl butyrate. Preferably the varnish is applied prior to the application of the antistatic coating.

In a further embodiment the film may be optionally coated with one or more radiation-curable resins, for example a resin which is curable by actinic radiation such as UV radiation, X-rays or electron beams. In one embodiment, the resin is an acrylic-based, UV-curable material. Preferably the resin is applied prior to the application of the antistatic coating.

Mixtures of varnishes and resins may be utilised.

Suitable polymeric substrates may comprise, for example, those made from polyolefins such as polypropylene and polyethylene; polyamides exemplified by nylon; polyester such as polyethylene terephthalate; polyacetal; polycarbonate; polyvinyl chloride and the like or a composite material of two or more materials, such as a laminate of paper and at least one polymeric material, or of two or more polymeric materials.

In addition, the polymeric substrate may comprise a polymer laminate. Such laminates include polymer-polymer laminates like polyester-polyolefin or polyester-adhesive-polyolefin, polymer-metallic laminates such as polyester-aluminum, or polymer-paper or polymer-adhesive-paper laminates. Coated polymer films or film laminates can also be used.

Preferably the polymeric substrate comprises a polymer selected from the group consisting of ethylene homopolymers, propylene homopolymers, interpolymers of ethylene and propylene and interpolymers of ethylene or propylene with one or more C₄-C₁₀ α-olefins and mixtures thereof.

In a preferred embodiment the polymeric substrate comprises a biaxially oriented polypropylene.

The polymeric substrates may be of a variety of thicknesses according to the application requirements. For example they can be from about 5 to about 250 micron thick, preferably from about 10 to about 120 micron thick, more preferably from about 12 to about 100 micron thick, and most preferably from about 15 to about 80 micron thick.

In some embodiments the antistatic coating comprises a compound selected from the group consisting of long chain aliphatic amines or amides, quaternary ammonium salts, polyethyleneglycol esters and polyols.

In other embodiments the antistatic coating comprises one or more metal or metalloid oxides. Suitable metal or metalloid oxides include oxides of aluminum, antimony, barium, bismuth, cadmium, calcium, cerium, cesium, chromium, cobalt, copper, dysprosium, erbium, gadolinium, germanium, hafnium, holmium, indium, iridium, iron, lanthanum, lead, lithium, lutetium, magnesium, manganese, molybdenum, neodymium, nickel, niobium, palladium, potassium, praseodymium, rhodium, rubidium, ruthenium, samarium, scandium, silicon, silver, sodium, strontium, tantalum, terbium, thallium, tin, titanium, tungsten, vanadium, ytterbium, yttrium, zirconium, and mixtures thereof.

A particularly preferred metal oxide is indium tin oxide.

In some embodiments the one or more metal oxides are dispersed in one or more resins or one or more solvents. Mixtures of resins and solvents may also be utilised.

The resin may be one or more radiation-curable resins, for example a resin which is curable by actinic radiation such as UV radiation, X-rays or electron beams. In one embodiment, the resin comprises an acrylic-based, UV-curable material.

In other embodiments the antistatic coating comprises one or more conducting polymers. The conducting polymer may be selected from the group consisting of polyfluorenes, polyphenylenes, polypyrenes, polyazulenes, polynapthalenes, polypyroles, polycarbazoles, polyindoles, polyazepines, polyanilines, polythiophenes, poly(3,4-ethylenedioxythiophene), poly(p-phenylene sulphide), poly(acetylenes) and poly(p-phenylenevinylene).

In some embodiments mixtures of two or more of any of the aforementioned antistatic materials may be employed.

In some embodiments the antistatic coating has a dry coating thickness of about 0.001 microns to about 10 microns. Preferably, the antistatic coating has a dry coating thickness of about 0.01 microns to about 10 microns. More preferably, the antistatic coating has a dry coating thickness of about 0.1 to about 6 microns. Most preferably the antistatic coating has a dry coating thickness of between 1 and 6 microns.

In some embodiments the antistatic coating has a surface resistivity of less 1×10¹⁰ ohm per square, preferably less than 1×10⁸ ohm per square.

The antistatic films may be of a variety of thicknesses according to the application requirements. For example they can be from about 5 to about 250 micron thick, preferably from about 10 to about 120 micron thick, more preferably from about 12 to about 100 micron thick, and most preferably from about 15 to about 80 micron thick.

The films according to this aspect may comprise one or more additive materials which are well known in the art of polymer film manufacture. Additives may include particulate additives.

In one embodiment the film is a security document. In another embodiment the film is a banknote.

According to a second aspect there is provided a method of manufacturing a film having antistatic properties, said method comprising:
(a) providing a polymeric substrate having opacified and non-opacified regions, said substrate having a first surface and a second surface;
(b) optionally printing on one or more opacified regions;
(c) optionally coating at least one surface with a protective coating; and
(d) coating both the opacified and non-opacified regions on at least one surface with one or more antistatic coatings.

In preferred embodiments the opacified and non-opacified regions of the polymeric substrate are coated with an antistatic coating on both surfaces of the substrate.

Preferably the antistatic coating is colourless.

In some embodiments the optional protective coating of step (c) may comprise a transparent varnish. By varnish it is meant a material that results in a durable protective finish. Exemplary transparent varnishes are, but are not limited to, nitrocellulose and cellulose acetyl butyrate.

In a further embodiment the optional coating of step (d) may comprise one or more radiation-curable resins, for example a resin which is curable by actinic radiation such as UV radiation, X-rays or electron beams. In one embodiment, the resin is an acrylic-based, UV-curable material.

Mixtures of varnishes and resins may be utilised.

Suitable polymeric substrates for use in the above method may comprise, for example, those made from polyolefins such as polypropylene and polyethylene; polyamides exemplified by nylon; polyester such as polyethylene terephthalate; polyacetal; polycarbonate; polyvinyl chloride and the like or a composite material of two or more materials, such as a laminate of paper and at least one polymeric material, or of two or more polymeric materials.

In addition, the polymeric substrate may comprise a polymer laminate. Such laminates include polymer-polymer laminates like polyester-polyolefin or polyester-adhesive-polyolefin, polymer-metallic laminates such as polyester-aluminum, or polymer-paper or polymer-adhesive-paper laminates. Coated polymer films or film laminates can also be used.

Preferably the polymeric substrate comprises a polymer selected from the group consisting of ethylene homopolymers, propylene homopolymers, interpolymers of ethylene and propylene and interpolymers of ethylene or propylene with one or more C₄-C₁₀ α-olefins and mixtures thereof.

In a preferred embodiment the polymeric substrate comprises a biaxially oriented polypropylene.

The polymeric substrates for use in the above method may be of a variety of thicknesses according to the application requirements. For example they can be from about 5 to about 250 micron thick, preferably from about 10 to about 120 micron thick, more preferably from about 12 to about 100 micron thick, and most preferably from about 15 to about 80 micron thick.

In some embodiments the antistatic coating used in the above method comprises a compound selected from the group consisting of long chain aliphatic amines or amides, quaternary ammonium salts, polyethyleneglycol esters and polyols.

In other embodiments the antistatic coating used in the above method comprises one or more metal or metalloid oxides. Suitable metal or metalloid oxides include oxides of aluminum, antimony, barium, bismuth, cadmium, calcium, cerium, cesium, chromium, cobalt, copper, dysprosium, erbium, gadolinium, germanium, hafnium, holmium, indium, iridium, iron, lanthanum, lead, lithium, lutetium, magnesium, manganese, molybdenum, neodymium, nickel, niobium, palladium, potassium, praseodymium, rhodium, rubidium, ruthenium, samarium, scandium, silicon, silver, sodium, strontium, tantalum, terbium, thallium, tin, titanium, tungsten, vanadium, ytterbium, yttrium, zirconium, and mixtures thereof.

A particularly preferred metal oxide is indium tin oxide.

In some embodiments the one or more metal oxides may be dispersed in one or more resins or one or more solvents so as to facilitate the coating process. Mixtures of resins and solvents may also be utilised.

The resin may be one or more radiation-curable resins, for example a resin which is curable by actinic radiation such as UV radiation, X-rays or electron beams. In one embodiment, the resin comprises an acrylic-based, UV-curable material.

In other embodiments the antistatic coating used in the above method comprises one or more conducting polymers. The conducting polymer may be selected from the group consisting of polyfluorenes, polyphenylenes, polypyrenes, polyazulenes, polynapthalenes, polypyroles, polycarbazoles, polyindoles, polyazepines, polyanilines, polythiophenes, poly(3,4-ethylenedioxythiophene), poly(p-phenylene sulphide), poly(acetylenes) and poly(p-phenylenevinylene).

In some embodiments mixtures of two or more of any of the aforementioned antistatic materials may be employed.

In some embodiments the antistatic coating used in the above method has a dry coating thickness of about 0.001 microns to about 10 microns. Preferably, the antistatic coating has a dry coating thickness of about 0.01 microns to about 10 microns. More preferably, the antistatic coating has a dry coating thickness of about 0.1 to about 6 microns. Most preferably the antistatic coating has a dry coating thickness of between 1 and 6 microns.

In some embodiments the antistatic coating used in the above method has a surface resistivity of less 1×10¹⁰ ohm per square, preferably less than 1×10⁸ ohm per square.

The antistatic films produced by the method may be of a variety of thicknesses according to the application requirements. For example they can be from about 5 to about 250 micron thick, preferably from about 10 to about 120 micron thick, more preferably from about 12 to about 100 micron thick, and most preferably from about 15 to about 80 micron thick.

The films produced by this aspect may comprise one or more additive materials which are well known in the art of polymer film manufacture. Additives may include particulate additives.

In one embodiment the film produced by the method is a security document. In another embodiment the film is a banknote.

According to a third aspect there is provided a use of the antistatic film as hereinbefore described in the manufacture of a security document. Preferably the security document is a banknote.

According to a fourth aspect there is provided an article of manufacture comprising the film according to any of the aforementioned embodiments. In one embodiment the article is a security document, preferably a banknote.

Throughout this specification, use of the terms “comprises” or “comprising” or grammatical variations thereon shall be taken to specify the presence of stated features, integers, steps or components but does not preclude the presence or addition of one or more other features, integers, steps, components or groups thereof not specifically mentioned.

### BRIEF DESCRIPTION OF THE DRAWINGS

Preferred embodiments will now be described with reference to the accompanying drawing in which:

FIG. 1 schematically shows a partially opacified polymeric substrate having an antistatic coating thereon.

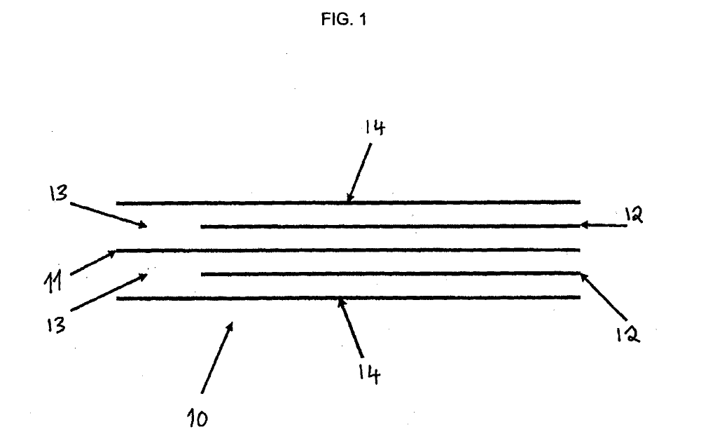

### DETAILED DESCRIPTION OF THE EMBODIMENTS

### Definitions

### Security Device or Feature

As used herein, the term ‘security device or feature’ includes any one of a large number of security devices, elements or features intended to protect the security document or token from counterfeiting, copying, alteration or tampering. Security devices or features may be provided in or on the substrate of the security document or in or on one or more layers applied to the base substrate, and may take a wide variety of forms, such as security threads embedded in layers of the security document; security inks such as fluorescent, luminescent and phosphorescent inks, metallic inks, iridescent inks, photochromic, thermochromic, hydrochromic or piezochromic inks; printed and embossed features, including relief structures; interference layers; liquid crystal devices; lenses and lenticular structures; optically variable devices (OVDs) such as diffractive devices including diffraction gratings, holograms and diffractive optical elements (DOEs).

### Diffractive Optical Elements (DOEs)

As used herein, the term ‘diffractive optical element’ refers to a numerical-type diffractive optical element (DOE). Numerical-type diffractive optical elements (DOEs) rely on the mapping of complex data that reconstruct in the far field (or reconstruction plane) a two-dimensional intensity pattern. Thus, when substantially collimated light, e.g. from a point light source or a laser, is incident upon the DOE, an interference pattern is generated that produces a projected image in the reconstruction plane that is visible when a suitable viewing surface is located in the reconstruction plane, or when the DOE is viewed in transmission at the reconstruction plane. The transformation between the two planes can be approximated by a fast Fourier transform (FFT). Thus, complex data including amplitude and phase information has to be physically encoded in the micro-structure of the DOE. This DOE data can be calculated by performing an inverse FFT transformation of the desired reconstruction (i.e. the desired intensity pattern in the far field).

DOEs are sometimes referred to as computer-generated holograms, but they differ from other types of holograms, such as rainbow holograms, Fresnel holograms and volume reflection holograms.

### Transparent Windows and Half Windows

As used herein the term window refers to a transparent or translucent area in the security document compared to the substantially opaque region to which printing is applied. The window may be fully transparent so that it allows the transmission of light substantially unaffected, or it may be partly transparent or translucent partially allowing the transmission of light but without allowing objects to be seen clearly through the window area.

A window area may be formed in a polymeric security document which has at least one layer of transparent polymeric material and one or more opacifying layers applied to at least one side of a transparent polymeric substrate, by omitting at least one opacifying layer in the region forming the window area. If opacifying layers are applied to both sides of a transparent substrate a fully transparent window may be formed by omitting the opacifying layers on both sides of the transparent substrate in the window area.

A partly transparent or translucent area, hereinafter referred to as a “half-window”, may be formed in a polymeric security document which has opacifying layers on both sides by omitting the opacifying layers on one side only of the security document in the window area so that the “half-window” is not fully transparent, but allows some light to pass through without allowing objects to be viewed clearly through the half-window.

Alternatively, it is possible for the substrates to be formed from an substantially opaque material, such as paper or fibrous material, with an insert of transparent plastics material inserted into a cut-out, or recess in the paper or fibrous substrate to form a transparent window or a translucent half-window area.

### Opacifying Layers

One or more opacifying layers may be applied to a transparent substrate to increase the opacity of the security document. An opacifying layer is such that L_{T}<L₀, where L₀ is the amount of light incident on the document, and L_{T} is the amount of light transmitted through the document. An opacifying layer may comprise any one or more of a variety of opacifying coatings. For example, the opacifying coatings may comprise a pigment, such as titanium dioxide, dispersed within a binder or carrier of heat-activated cross-linkable polymeric material. Alternatively, a substrate of transparent plastic material could be sandwiched between opacifying layers of paper or other partially or substantially opaque material to which indicia may be subsequently printed or otherwise applied.

Opacification may also be achieved by inclusion of voiding agents in the substrate, during, for example, substrate manufacture.

It will now be convenient to describe the invention with reference to particular embodiments and examples. These embodiments and examples are illustrative only and should not be construed as limiting upon the scope of the invention. It will be understood that variations upon the described invention as would be apparent to the skilled addressee are within the scope of the invention. Similarly, the present invention is capable of finding application in areas that are not explicitly recited in this document and the fact that some applications are not specifically described should not be considered as a limitation on the overall applicability of the invention.

With reference to the FIGURE, film (10) comprises a polymeric substrate (11) which is partially coated on each of its surfaces with an opacifying layer (12). Windows (13) result. The partially opacified polymeric substrate is coated on each surface with antistatic coating (14).

Polymeric Substrate

The substrates referred to herein are generally sheet-form materials, and may be provided as individual sheets, or as a web material which may subsequently be processed (by die cutting for example) to provide sheet form materials. When referring to “substrate” in this specification it is intended, unless expressly provided otherwise, to include films in sheet or web form.

The substrate may comprise a polyolefin film, for example polyethylene, polypropylene, mixtures thereof, and/or other known polyolefins. The polymeric film can be made by any process known in the art, including, but not limited to, cast sheet, cast film, or blown film. The film or sheet may be of mono layer or of multi-layer construction. If the film or sheet is of multi-layer construction then it has at least one core layer therein. In the case of a mono layer construction the mono-layer is the core layer. The film may comprise a biaxially orientated polypropylene (BOPP) film, which may be prepared as balanced films using substantially equal machine direction and transverse direction stretch ratios, or can be unbalanced, where the film is significantly more orientated in one direction (MD or TD). Sequential stretching can be used, in which heated rollers effect stretching of the film in the machine direction and a stenter oven is thereafter used to effect stretching in the transverse direction. Alternatively, simultaneous stretching, for example, using the so-called bubble process, or simultaneous draw stenter stretching may be used.

The film may comprise one or more additive materials. Additives may comprise: dyes; pigments, colorants; metallised and/or pseudo metallised coatings (e.g. aluminium); lubricants, anti-oxidants, surface-active agents, stiffening aids, gloss-improvers, prodegradants, UV attenuating materials (e.g. UV light stabilisers); sealability additives; tackifiers, anti-blocking agents, additives to improve ink adhesion and/or printability, cross-linking agents; adhesive layer (e.g. a pressure sensitive adhesive). Further additives comprise those to reduce coefficient of friction (COF) such as a terpolymer.

Further additives comprise conventional inert particulate additives, preferably having an average particle size of from about 0.2 micron to about 5 micron, more preferably from about 0.7 micron to about 3.0 micron. Decreasing the particle size improves the gloss of the film. The amount of additive, preferably spherical, incorporated into the or each layer is desirably in excess of about 0.05%, preferably from about 0.1% to about 0.5%, for example, about 0.15%, by weight. Suitable inert particulate additives may comprise an inorganic or an organic additive, or a mixture of two or more such additives.

Suitable particulate inorganic additives include inorganic fillers such as talc, and particularly metal or metalloid oxides, such as alumina and silica. Solid or hollow, glass or ceramic micro-beads or micro-spheres may also be employed. A suitable organic additive comprises particles, preferably spherical, of an acrylic and/or methacrylic resin comprising a polymer or copolymer of acrylic acid and/or methacrylic acid.

Some or all of the desired additives listed above may be added together as a composition to coat the film of the present invention and/or form a new layer which may itself be coated (i.e. form one of the inner layers of a final multi-layered sheet) and/or may form the outer or surface layer of the sheet. Alternatively some or all of the preceding additives may be added separately and/or incorporated directly into the bulk of the sheet optionally during and/or prior to the sheet formation (e.g. incorporated as part of the original polymer composition by any suitable means for example compounding, blending and/or injection) and thus may or may not form layers or coatings as such.

Such additives may be added to the polymer resin before the film is made, or may be applied to the made film as a coating or other layer. If the additive is added to the resin, the mixing of the additives into the resin is done by mixing it into molten polymer by commonly used techniques such as roll-milling, mixing in a Banbury type mixer, or mixing in an extruder barrel and the like. The mixing time can be shortened by mixing the additives with unheated polymer particles so as to achieve substantially even distribution of the agent in the mass of polymer, thereby reducing the amount of time needed for intensive mixing at molten temperature. The most preferred method is to compound the additives with resin in a twin-screw extruder to form concentrates which are then blended with the resins of the film structure immediately prior to extrusion.

The three main methods of manufacturing polypropylene film are the stenter method, the cast method and the bubble method.

In the cast and stenter methods, polymer chips are typically placed in an extruder and heated so that an extrudate is forced out of a slit die onto a chilled roller to form a film (in the case of the cast method) or a thick polymer ribbon (in the case of the stenter method). In the stenter method, the thick polymer ribbon is then reheated and then stretched lengthways (termed the (“machine direction”) and widthways (termed the “transverse direction”) to form a film.

In the bubble method, the polymer is extruded not through a slit die but through an annular die, to form a relatively thick extrudate, in the form of a hollow cylinder through which air is blown. The annular die is at the top of an apparatus which is typically the equivalent of several storeys high (for example 40 to 50 metres). The extrudate moves downwards and is heated sequentially so that it is expanded to form a bubble. The bubble is then slit into two half-bubbles, each of which may be used individually as “monoweb” films; or alternatively the two halves may be nipped and laminated together to form a double thickness film (or the bubble may be collapsed to form a double thickness film). Typically there are three concentric annuli at the die, so that the hollow cylinder is an extrudate of three layers. For example, there may be a core layer of polypropylene with a terpolymer skin layer on one side and another terpolymer skin layer on the other side. In this case the monoweb would consist of three layers with polypropylene in the middle and the double web would consist of five layers because the layer in the middle would be the same skin layer (terpolymer) of each half-bubble. Many other possible arrangements and components are possible, for example in terms of the number of annuli, type of skin layer, type of core layer, etc.

Thus the bubble method results in a thin film (for example 10 to 100 microns thick) by forming a bubble whereas the stenter method results in a thin film by stretching the material. The bubble method results in homogeneously stretched film which is different to and for some purposes advantageous over stenter film. Biaxially Oriented Polypropylene (BOPP) film is typically made by the bubble process. In addition to polypropylene, other polymers (e.g. LLDPE, polypropylene/butylene copolymers) may also be formed as thin films using the bubble process.

Formation of a polyolefin film (optionally oriented and optionally heat-set as described herein) which comprises one or more additional layers and/or coatings is conveniently effected by any of the laminating or coating techniques well known to those skilled in the art.

For example a layer or coating can be applied to another base layer by a coextrusion technique in which the polymeric components of each of the layers are coextruded into intimate contact while each is still molten. Preferably, the coextrusion is effected from a multi-channel annular die such that the molten polymeric components constituting the respective individual layers of the multi-layer film merge at their boundaries within the die to form a single composite structure which is then extruded from a common die orifice in the form of a tubular extrudate.

A polyolefin film may also be coated with one or more of the additives described herein using conventional coating techniques from a solution or dispersion of the additive in a suitable solvent or dispersant.

Coatings and/or layers may be applied to either or both surfaces of the polyolefin film. The one or each coating and/or layer may be applied sequentially, simultaneously and/or subsequently to any or all other coatings and/or layers

Additionally or alternatively further layers can be provided in the polyolefin film by coextrusion through a multiple-annuli die, to produce for example two, three, four or more layers in the coextrudate exiting the die.

It would also be possible to use combinations of more than one of the above methods of applying additives and/or components thereof to a polyolefin film. For example one or more additives may be incorporated into the resin prior to making the film and the one or more other additives may be coated onto the film surface.

### Opacifiying Layers

The substrate has at least one region thereon having reduced opacity compared to the surrounding substrate. The polymeric substrate may be opacified by printing on one or both surfaces with ink. The ink is usually white in colour but may be of a different colour.

Alternatively or additionally, the opacity of the substrate may be at least partially provided by the presence in the substrate of voided (or cavitated) regions. Such voided regions may for example be created by providing in the substrate at least one voiding agent. The production of voided films is well known in the art, and any suitable voiding agent may be used. Voiding agents are generally particulate materials and may be selected from organic, inorganic or polymeric materials. U.S. Pat. No. 4,377,616 describes a number of these. Voiding agents may be substantially spherical particulate in nature, or may have a higher aspect ratio. For example, the voiding agents described in WO-A-03/033574 may be used.

The opacified polymer substrate may be printed in the opacified regions using traditional offset, intaglio and letterpress processes.

### Antistatic Coatings

The antistatic coating may comprise a compound selected from the group consisting of long chain aliphatic amines or amides, quaternary ammonium salts, polyethyleneglycol esters and polyols.

Alternatively or additionally the antistatic coating comprises one or more metal oxides. Suitable metal oxides include oxides of aluminum, antimony, barium, bismuth, cadmium, calcium, cerium, cesium, chromium, cobalt, copper, dysprosium, erbium, gadolinium, germanium, hafnium, holmium, indium, iridium, iron, lanthanum, lead, lithium, lutetium, magnesium, manganese, molybdenum, neodymium, nickel, niobium, palladium, potassium, praseodymium, rhodium, rubidium, ruthenium, samarium, scandium, silicon, silver, sodium, strontium, tantalum, terbium, thallium, tin, titanium, tungsten, vanadium, ytterbium, yttrium, zirconium, and the like.

Alternatively or additionally the antistatic coating comprises one or more conducting polymers. The conducting polymer may be selected from the group consisting of polyfluorenes, polyphenylenes, polypyrenes, polyazulenes, polynapthalenes, polypyroles, polycarbazoles, polyindoles, polyazepines, polyanilines, polythiophenes, poly(3,4-ethylenedioxythiophene), poly(p-phenylene sulphide), poly(acetylenes) and poly(p-phenylenevinylene).

An antistatic coating may be applied to the surface of the substrate in any suitable manner such as by gravure printing, roll coating, rod coating, dipping, spraying and/or using a coating bar. Solvents, diluents and adjuvants may also be used in these processes as desired. The excess liquid (e.g. aqueous solution) can be removed by any suitable means such as squeeze rolls, doctor knives and/or air knives. The coating composition will ordinarily be applied in such an amount that there will be deposited following drying, a smooth, evenly distributed layer having a thickness of from about 0.01 to about 10 micron, preferably from about 1 to about 6 micron. In general, the thickness of the applied coating is such that it is sufficient to impart the desired characteristics to the substrate sheet.

Among the various transparent and conductive metal oxides for antistatic coating materials, indium tin oxide (ITO) is an attractive material that offers good physical properties. ITO thin films can be used for various applications that require both optical transparency in the visible light region and high electrical conductivity. There are various techniques available to deposit ITO film on a substrate surface including chemical vapour deposition, physical vapour deposition, electron beam evaporation and sputtering. However, these methods are not well suited for the mass production of coated films since additional apparatus such as vacuum equipment is necessary. However, it is possible to form a coating layer with uniform thickness on a substrate having large surface area if a wet coating method is applied. In this method, a coating solution containing ITO precursors or ITO nanoparticles can be deposited on the substrate by a dip-coating or spin-coating technique.

### Coating Methods

In-line coating of the opacified polymer substrate, in which the antistatic coatings are applied during the film manufacturing process is a preferred method for use of the antistatic coatings disclosed herein.

In addition to in-line coating, one or more of the antistatic coatings may be off-line coated. Thus, the coating is also intended for use where, for example, the base polymer film is produced and later coated off-line with one or more coatings. Alternatively, one or more coatings can be applied in-line, with the remainder being applied off-line. Conventional off-line coating processes include roll coating, reverse roll coating, gravure roll coating, reverse gravure roll coating, brush coating, wire-wound rod coating, spray coating, air knife coating, meniscus coating or dipping.

In light of the foregoing, a preferred method of controlling static formation on a partially opacified polymeric substrate is provided herein. Preferably, one or both surfaces of a partially opacified polymeric substrate are coated with an antistatic coating. Optionally, if only one surface is coated with the antistatic coating, this coating can occur before, after or at the same time the opposite surface of the polymeric substrate is coated with an alternate coating. The antistatic coating is preferably not overcoated with another coating. Such a top coating could limit the ability of the antistatic coating to prevent static.

1. A film having antistatic properties, said film comprising a transparent polymeric substrate, said substrate having a first surface and a second surface, said substrate being partially opacified on at least one surface so as to provide opacified and non-opacified regions and wherein both the opacified and non-opacified regions are coated on both surfaces with an antistatic coating, said coating having greater than 70% transmission.

2. The film according to claim 1 wherein the antistatic coating has greater than 80% transmission.

3. The film according to claim 1 wherein the antistatic coating has greater than 90% transmission.

4. The film according to claim 1,
wherein the polymeric substrate comprises a polymer selected from the group consisting of ethylene homopolymers, propylene homopolymers, interpolymers of ethylene and propylene, interpolymers of ethylene or propylene with one or more C₄-C₁₀ α-olefins, polyamides, polyesters, polyacetals, polycarbonates, polyvinyl chloride and mixtures thereof.

5. The film according to claim 1, wherein the polymeric substrate is partially opacified on both surfaces.

6. The film according to claim 1, wherein the opacified regions result from coating the transparent polymeric substrate with an opacifying coating, including one or more opacifying layers in the film, or including voiding agents in the substrate, or combinations thereof.

7. (canceled)

8. The film according to claim 1, wherein the antistatic coating is colourless.

9. The film according to claim 1, wherein the polymeric substrate comprises a biaxially oriented polypropylene.

10. The film according to claim 1, wherein the antistatic coating comprises a compound selected from the group consisting of long chain aliphatic amines or amides, quaternary ammonium salts, polyethyleneglycol esters and polyols.

11. The film according to claim 1, wherein the antistatic coating comprises one or more metal or metalloid oxides selected from the group consisting of aluminum, antimony, barium, bismuth, cadmium, calcium, cerium, cesium, chromium, cobalt, copper, dysprosium, erbium, gadolinium, germanium, hafnium, holmium, indium, iridium, iron, lanthanum, lead, lithium, lutetium, magnesium, manganese, molybdenum, neodymium, nickel, niobium, palladium, potassium, praseodymium, rhodium, rubidium, ruthenium, samarium, scandium, silicon, silver, sodium, strontium, tantalum, terbium, thallium, tin, titanium, tungsten, vanadium, ytterbium, yttrium and zirconium oxides.

12. The film according to claim 11 wherein the metal oxide comprises indium tin oxide.

13. The film according to claim 11, wherein the one or more metal oxides is dispersed in a resin.

14. The film according to claim 1 wherein the antistatic coating comprises one or more conducting polymers.

15. The film according to claim 14 wherein the conducting polymer is selected from the group consisting of polyfluorenes, polyphenylenes, polypyrenes, polyazulenes, polynapthalenes, polypyroles, polycarbazoles, polyindoles, polyazepines, polyanilines, polythiophenes, poly(3,4-ethylenedioxythiophene), poly(p-phenylene sulphide), poly(acetylenes) and poly(p-phenylenevinylene).

16. The film according to claim 1, wherein the antistatic coating has a dry coating thickness of about 0.001 microns to about 10 microns.

17. The film according to claim 16, wherein the antistatic coating has a dry coating thickness of about 1 microns to about 6 microns.

18. The film according to claim 1 wherein the antistatic coating has a surface resistivity of less than 1×10¹⁰ ohms per square, preferably less than 1×10⁸ ohms per square.

19. A method of manufacturing a film having antistatic properties, said method comprising:
(a) providing a polymeric substrate having opacified and non-opacified regions, said substrate having a first surface and a second surface;
(b) optionally printing on one or more of the opacified regions;
(c) optionally coating at least one surface with a protective coating; and
(d) coating both the opacified and non-opacified regions on at least both surfaces with one or more antistatic coatings.

20. The method according to claim 19 wherein the protective coating in step (c) is a varnish, a resin or mixtures thereof.

21. The use of an antistatic film according to claim 1 in the manufacture of a security document.

22. The use according to claim 21 wherein the security document is a banknote.

23. An article of manufacture comprising the film according to claim 1.

24. The article according to claim 23 wherein the article is a banknote.
